(19) United States
(12) Patent Application Publication
(10) Pub. No.: US 2005/0068790 A1
(43) Pub. Date: Mar. 31, 2005

(54) Light emitting diode glow tube

(76) Inventor: David A. Love, Orillia (CA)

Correspondence Address: HARNESS, DICKEY & PIERCE, P.L.C., P.O. BOX 828, BLOOMFIELD HILLS, MI, 48303, US

(21) Appl. No.: 10/947,492

(22) Filed: Sep. 22, 2004

Related U.S. Application Data
(60) Provisional application No. 60/506,306, filed on Sep. 25, 2003.

(51) Int. Cl. B60Q 1/00

(52) U.S. Cl. 362/555

(57) ABSTRACT

A method of accent lighting and an accent light including an LED and a light guide with polished proximal and distal ends. The LED is optically coupled to the proximal end and the distal end reflects the LED light back into the guide. Additionally, the distal end may include a reflective coating and the guide may be acrylic. Moreover, the guide may be supported by a vinyl support glued to the guide whereby the light output about doubles. Also, a longitudinal etch on the acrylic guide may make the light output about consistent along the guide.

### FIELD OF THE INVENTION

The present invention relates to accent lighting, and more particularly to low light output accent lighting

### BACKGROUND OF THE INVENTION

Many consumers prefer to decorate their belongings with accent lights. Recently, for example, accent lights for automobiles, RV's and other vehicles have become popular. For another example, consumers frequently purchase hot tubs, saunas, and other leisure goods decorated with accent lights. Additionally, after market accent lights may be purchased by the consumer to decorate belongings which they already own, such as decks, patios, dock systems and so on. Likewise, low intensity lights (similar to accent lights) are preferred for location finding (e.g. in darkened theaters, outdoor areas at night, or pathways) and other general marking applications.

Incandescent lights generally suffer from a number of disadvantages, which make them unsuitable for use as accent lights. First, they tend to be unreliable and prone to damage resulting in light failure, particularly from vibration, shock and corrosion. Moreover, an incandescent light consumes a relatively large amount of power, most of which is lost as sensible heat, not emitted as visible light, resulting in low efficiencies. Additionally, incandescent lights can cast a harsh light from a concentrated point source which further makes them unsuitable for use as accent lights in low ambient light conditions.

Neon tube lights have also been employed as accent lights. But neon accent lights also suffer from disadvantages similar to those of incandescent lights. Neon lights are fragile and require excessive power in comparison to solid state LED lighting. Neon lights are also generally too bright for use as accent lights, particularly in low ambient light conditions. Thus, a need exists for accent lights which are highly reliable, damage resistant, and consume very little power (thereby creating little sensible heat) yet which still provide a diffuse, low intensity light, useful in low ambient light conditions.

### SUMMARY OF THE INVENTION

A method of accent lighting and an accent light is provided by the present invention.

In particular the present invention includes a glow tube accent light which has an end-lit acrylic light guide acting as both a light diffuser and emitter. Since the light guide of the present invention possesses high light transmission efficiency, the glow tube may require only a single LED which is optically coupled to one end of the light guide to provide adequate accent illumination. To enhance the efficiency of the light guide, the end opposite the LED may be made optically reflective with a white coating. Thus, the opposite end reflects emitted light from the LED back into the light guide.

Further efficiency enhancements may be included in the glow tubes of the present invention. For instance, the ends of the light guide may be smoothed to a mirror finish by clean flame polishing. Additionally, the light guide may be adhered to the light guide track housing. The adhesive creates a light seal which results in the light from the LED impinging on the track side of the light guide to be reflected to the front of the light guide. Thus, the light seal significantly increases the light output of the glow tube. Moreover, to enhance the consistency of the light output along the length of the light guide, longitudinal etches may be added to the light guide to more evenly distribute the light emission along the light guide. Accordingly, the LED illuminates the glow tube to a level and consistency suitable for viewing in low ambient light environments.

In a first embodiment, the accent light includes an LED and a light guide with proximal and distal ends. The LED is optically coupled to the proximal end and the distal end reflects the LED light back into the guide. Additionally, the distal end may include a reflective coating and the guide may be acrylic. Moreover, the guide may be supported by a vinyl housing adhered to the light guide whereby the light output of the glow tube in the viewing direction is increased significantly relative to an isolated light guide. Also, a longitudinal etch on the acrylic guide may make the light output reasonably consistent along the guide. Thus, the present invention provides accent lights which diffuse and output a high percentage of the source light emitted by the LED.

In another embodiment, a method of enhancing the light output from an accent light is provided. The method includes optically coupling a light emitting diode to a proximal end of a light guide and reflecting light from a distal end of the guide back into the guide. Additionally, the method may include coating the distal end with a white reflective material. Moreover, the light guide may be an acrylic tube. A support channel may also be provided for the acrylic tube and the two adhered together. Adding a support channel and adhering the channel to the acrylic tube significantly increases the light output of the accent light. Furthermore, a longitudinal etch may be made on the acrylic tube to make the diffuse light output along the length of the acrylic tube of a relatively uniform consistency. Thus, the present invention provides a method of enhancing the light output of an accent light to utilize a high percentage of the light emitted by the LED.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a recreational vehicle which includes accent lights in accordance with the present invention.

FIG. 2 is a perspective view of an accent light in accordance with a preferred embodiment of the present invention.

FIG. 3 is a cross sectional view of an accent light in accordance with a preferred embodiment of the present invention.

FIG. 4 is a flowchart of a method in accordance with a preferred embodiment of the present invention.

### DETAILED DESCRIPTION OF THE EMBODIMENTS

The following description of the embodiment(s) is merely exemplary in nature and is in no way intended to limit the invention, its application, or uses.

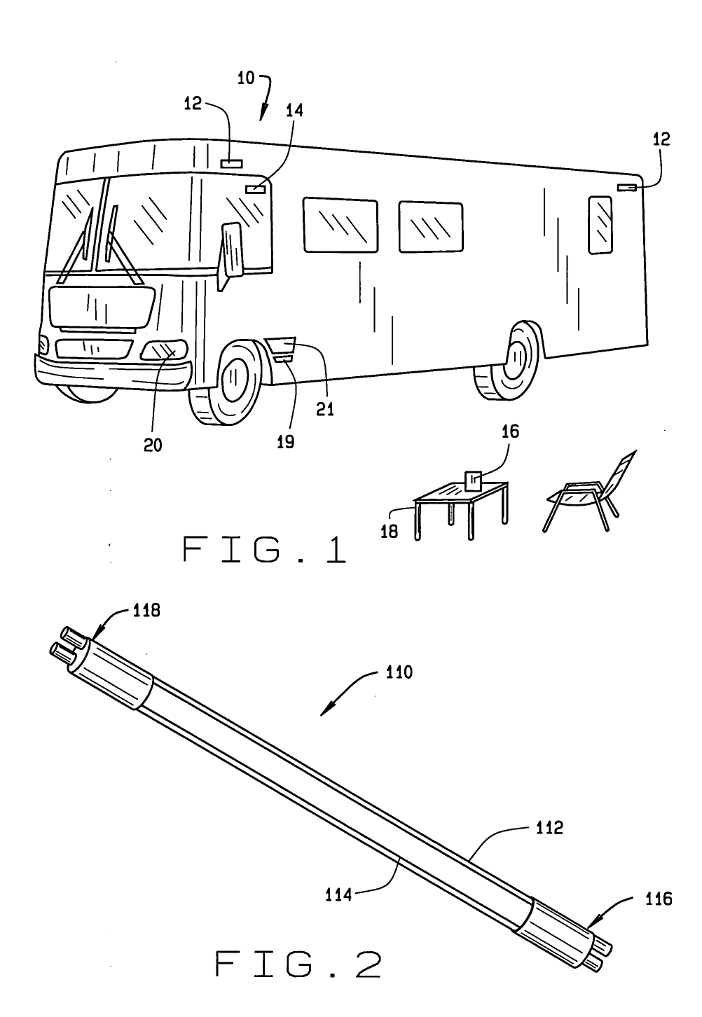

As seen in FIG. 1, consumers frequently decorate their consumer products by adding accent lights to the product and its environs. In the exemplary scene shown in FIG. 1, a recreational vehicle 10 represents a typical consumer good which may be decorated with accent lights. Accent lights 12 are shown along the top edge of the recreational vehicle 10. As well, accent lights 14 may be included within the cabin of the recreational vehicle 10. A battery powered accent light 16 may also be set on (or affixed to) structures 18 near the recreational vehicle 10. Additionally, a low intensity location marking light 19 may be provided on the edge of a step 21 leading into the recreational vehicle 10. Being exposed to the weather, the accent lights 12 and 16 and the marking light 19 are waterproof and weatherproof, though the accent lights provided by the present invention need not be waterproof or weatherproof.

Of course the recreational vehicle 10 also has conventional lights 20. However, conventional lights 20 generally create intense, harsh light which is generally unsuitable for use when the recreational vehicle is parked in a campground. Thus, at night, when others nearby may be sleeping, the user may turn off the conventional lights 20 and turn on the accent lights 12, 14, and 16. Thus, the bright and harsh conventional light is replaced by low intensity diffuse light from the accent lights. Conventional incandescent lighting also consumes far more energy than solid-state diffuse lighting, usually requiring the periodic running of a generator, or of the RV engine for a time to recharge the electrical system. Diffuse LED accent lights, operating at a nominal 0.3 watts apiece, compared with the typical 7 to 12 watts of an incandescent, require less energy and can operate for a proportionally longer period on an equivalent amount of stored energy.

Turning now to FIG. 2, a glow tube in accordance with a preferred embodiment of the present invention is shown. The glow tube 110 includes a support channel 112, a transparent or translucent light guide 114, and two end housings 116 and 118. The support channel 112 encloses the light guide 114 on all but the side(s) through which the user wishes light to escape from the glow tube 110. Also, the support channel 112 protects and supports the light guide in a recess diminished to hold the light guide 114. The support channel 112 may be made of polypropylene or vinyl, white being one particular reflective color for the support, to enhance light reflection. The end housings 116 and 118, when adhered to the support channel may clamp the assembly together and provide access for power leads (not shown), as well as containing the LED and associated lighting circuitry. Additionally, the end housings 116 and 118 may provide integral screw mounting attachment points to attach the glow tube 110 to various suitable structures or surfaces.

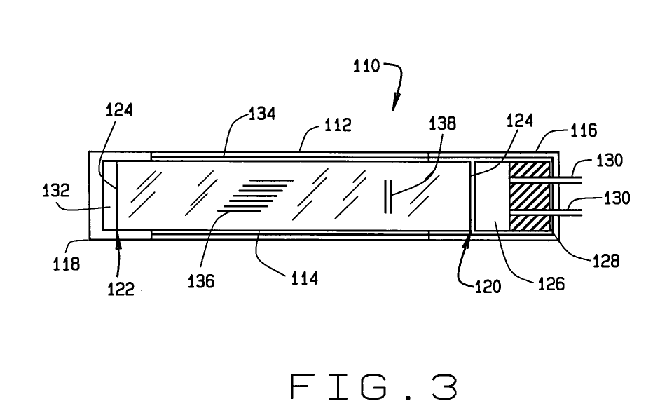

Turning now to FIG. 3, the accent light 110 is shown in cross section. In particular, the light guide 114 may be generally bar, or rod, shaped and includes a proximal end 120 and a distal end 122. Both ends may be polished to a mirror finish 124 of approximately 0.05 to 0.5 micron average surface roughness. In close proximity to, or abutting, the proximal end 120, an LED 126 with associated circuitry on a small printed circuit board (not shown) is held in place by the end housing 116 and is optically coupled to the proximal end 120. Additionally, potting resin 128 seals the LED 126 and associated circuitry against the environment and provides strain relief for a pair of electrical leads 130 which route power to the LED 126 and associated circuitry. Moreover, an electrical bridge and filter (not shown) may be provided either internally, or externally, to the glow tube to condition the electrical power for the LED 126, thereby eliminating sensible flickering and power supply polarity issues. In a preferred embodiment, the LED 126 is a 5 millimeter, through hole, narrow cone (approximately 20 degrees) LED. In another embodiment, the resin potting material seals any electronics internal to the glow tube 110 and is an electronic/electrical grade epoxy resin having a minimum cured hardness, Shore D of at least 65.

In contrast to the proximal end 120, and at the distal end 122, the end housing 118, identical to the end housing 116, encloses a reflector 132 in place against the distal end 122. The reflector 122 may be a separate component or may be a coating applied to the distal end 122. In certain embodiments, the reflector 132 may be a coating of reflective silvered or white ink applied to the distal end 122. By eliminating light leakage from the non illuminated distal end 122, and reflecting potential leakage light back into the light guide, the reflector 132 improves the efficiency of the light guide 114. Herein, efficiency refers to the percentage of light emitted from the LED which escapes from the glow tube in the desired direction(s). In the alternative, end housing 118 may hold a second LED in close proximity to the distal end 122, in an identical manner as proximal end 120, instead of the reflector 132.

Additionally, FIG. 3 shows a support channel 112 which may generally surround the light guide 114 on three sides, thereby allowing the light to escape from the light guide 114 along the remaining open side. Though, alternative embodiments may provide additional open sides from which light may escape. A sealant layer of adhesive 134 affixes the light guide 114 to the support channel 112. Additionally, by eliminating a path of light leakage from the light guide 114, the glue 134 serves as a “light seal” which tightly seals, surrounds and reflects light toward the open side, enhancing the efficiency of the light guide 114. The adhesive may be a polyurethane sealant or a general purpose silicon sealant. It has been found that the resulting adhesive light seal increases the effective light output of the light guide 114 through the remaining open side by approximately 30% and improves the uniformity of light distribution.

In another embodiment, the light guide 114 may be an acrylic rod. Moreover, a large number of fine longitudinal grooves, or etchings, 136 may be etched into the surface of the light guide 114. It has been found that the longitudinal etchings, as opposed to a ‘frosting’ or fine pitting of the surface, provide light concentrating deformities which promote diffuse illumination throughout the length of the light guide 114, without ‘shading’ of areas progressively distant from the illumination source. In another embodiment, the longitudinal etchings 136 run the length of the light guide 114, are approximately 0.05 millimeters deep, and are approximately 0.05 millimeters wide. In addition, the etchings 136 may be on the surface of the light guide 114 which is exposed by the opening in the support channel 112 or may cover the entire circumferential surface of the light guide 114. Supporting the unsuitability of a frosted, or fine pitted, surface, it has been found that eliminating, or avoiding, radial imperfections 138 and randomly orientated imperfections (e.g. sand blasting scratches and pits) further enhances the consistency of the light output by the light guide 114. In accordance with the present embodiment, a glow tube 114 is provided which has a light output which varies less than about 30% along the length of a light guide 114 of approximately 0.3 m in length.

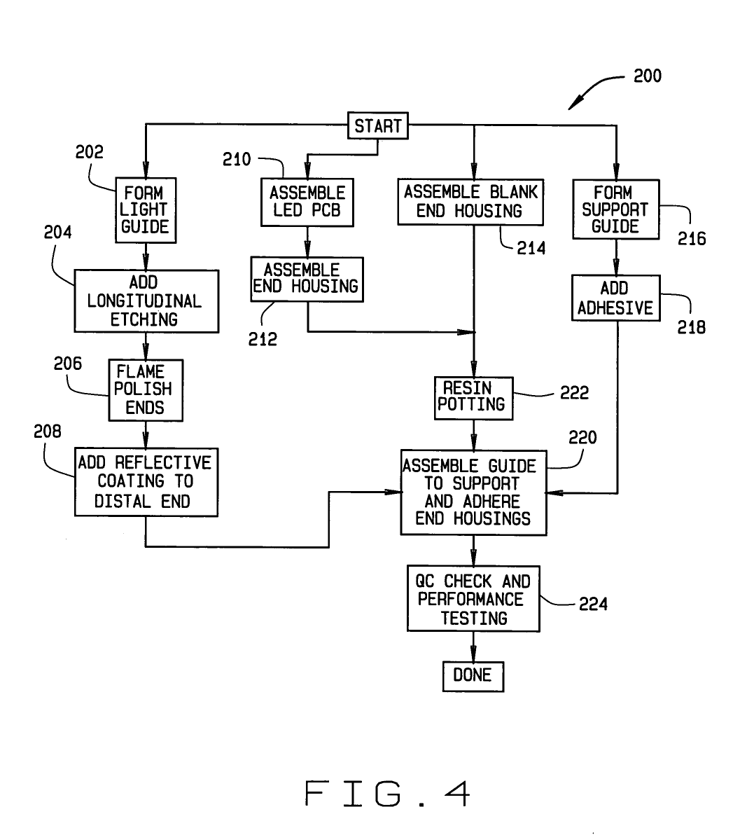

Turning now to FIG. 4, a method of fabricating a glow tube in accordance with the principles of the present invention is shown. The method 200 includes forming a light guide of the desired size. In particular, a 12.8 millimeter acrylic rod may be cut to preferred lengths of about 6 inches, about 12 inches, about 18 inches, and about 24 inches. Extra length may be included to accommodate attachment of the end caps. See step 202.

In step 204 longitudinal etches are added to the sides of the light guide. The un-etched sides may be polished to eliminate radial and randomly orientated imperfections to further improve the light guide's efficiency. Meanwhile in step 206 the ends of the light guide may be polished to a mirror finish. In particular clean flame polishing may be employed to flow the acrylic surfaces thereby eliminating surface irregularities. A reflective coating may then be added to the distal end of the light guide. See step 208.

In step 210 the assembly of the electronic components may begin with mounting the LED and other internal circuit components on a PCB (printed circuit board). In the meantime the end housings may be assembled or fabricated as in steps 212 and 214 along with assembling the PCB in one of the end housings. As well, the support channel, or guide, may be formed as in step 216.

Adhesive may then be applied to the support channel or the light guide and the channel and the guide assembled. See steps 218 and 220. Also, in step 222 the resin may be potted and applied to the LED (and other internal electronics). The end housings may then be affixed to the support channel as in step 220. Appropriate quality control and performance tests may then be conducted on the glow tube. See step 224.

As those skilled in the art will recognize, the present invention provides a solid state accent light suitable for a variety of applications. In particular, the glow tubes provided by the present invention are durable and resistant to vibration and shock. It is estimated that glow tubes in accordance with the present invention may have average lifetimes of 100,000 hours or better. Additionally, the present invention provides glow tubes which are relatively insensitive to significant temperature variations.

Also, the present invention provides LED end-lit glow tubes which require very little power relative to comparable incandescent lights, thereby being well suited for use with battery, or other limited stored energy power supplies. Accordingly, the glow tubes also produce little sensible heat. Additionally, the glow tubes of the present invention may be provided in any color for which an LED may be found. For instance, the present invention provides for red, green, blue, white, and amber glow tubes, thereby allowing wide consumer choice in color schemes. Furthermore, because of the high efficiency provided by the present invention, the light emitted from the glow tube may be intense enough so that operation of the glow tube (including its color) may be visually confirmed even in day time ambient light.

The description of the invention is merely exemplary in nature and, thus, variations that do not depart from the gist of the invention are intended to be within the scope of the invention. Such variations are not to be regarded as a departure from the spirit and scope of the invention.

1. An accent light comprising:
a light emitting diode to emit light; and
a light guide including a proximal and a distal end and optically coupled to the light emitting diode at the proximal end, the distal end being reflective, whereby the reflective distal end serves to reflect escaping light back into the light guide.

2. The accent light according to claim 1, wherein the reflective distal end further comprises a reflective coating, whereby the distal end to reflect light back into the light guide.

3. The accent light according to claim 2, wherein the reflective coating further comprises at least one of a white coating and a silvered ink based coating.

4. The accent light according to claim 1, wherein the light guide further comprises an acrylic tube.

5. The accent light according to claim 4, further comprising an extruded support disposed to support the acrylic tube and affixed to the acrylic tube by an adhesive, whereby the adhesive increases a light output of the accent light by approximately 30%.

6. The accent light according to claim 5, further comprising the support being made of one of vinyl and polypropylene.

7. The accent light according to claim 5, wherein the adhesive further comprises a sealant.

8. The accent light according to claim 4, wherein the acrylic tube further comprises a longitudinal etch whereby the resultant light output along the length of the acrylic tube is about consistent.

9. The accent light according to claim 8, wherein the etch is about 0.05 millimeters deep and about 0.05 millimeters wide.

10. The accent light according to claim 1, wherein the ends are flame polished to between about 0.05 micron and about 0.5 micron average surface roughness.

11. The accent light according to claim 1, wherein a light output of the accent light is at least about 60% of the total light emitted by the light emitting diode.

12. A method of enhancing a light output from an accent light, comprising:
optically coupling a light emitting diode to a proximal end of a light guide; and
reflecting light from a distal end of the guide back into the guide.

13. The method according to claim 12, further comprising coating the distal end with at least one of a reflective material

14. The method according to claim 13, wherein the reflective coating further comprises at least one of a silvered material and a white ink material.

15. The method according to claim 12, wherein the light guide further comprises an acrylic tube.

16. The method according to claim 15, further comprising:
supporting the acrylic tube with a support; and
applying an adhesive to affix the acrylic tube to the support thereby increasing a light output of the accent light by about 30%.

17. The method according to claim 16, wherein the adhesive further comprises a polyurethane sealant.

18. The method according to claim 16, further comprising the support being made from one of vinyl and polypropylene.

19. The method according to claim 15, further comprising etching a longitudinal etch on the acrylic tube whereby the light output along the length of the acrylic tube to be about consistent.

20. The method according to claim 19, wherein the etch is about 0.05 millimeters deep and about 0.05 millimeters wide.

21. The method according to claim 12, further comprising flame polishing the ends of the light guide to between about 0.05 micron and about 0.5 micron average surface roughness.

22. The method according to claim 12, further comprising outputting from the light guide at least 60% of the light emitted by the light emitting diode.
